(19) United States
(12) Patent Application Publication
(10) Pub. No.: US 2017/0219819 A1
(43) Pub. Date: Aug. 3, 2017

(54) OPTICAL ELEMENT AND METHOD OF MANUFACTURING OPTICAL ELEMENT

(71) Applicant: FUJIFILM Corporation, Tokyo (JP)

(72) Inventors: Shinichiro SONODA, Ashigara-kami-gun (JP); Tatsuya YOSHIHIRO, Ashigara-kami-gun (JP)

(73) Assignee: FUJIFILM Corporation, Tokyo (JP)

(21) Appl. No.: 15/487,958

(22) Filed: Apr. 14, 2017

Related U.S. Application Data
(63) Continuation of application No. PCT/JP2015/078224, filed on Oct. 5, 2015.

(30) Foreign Application Priority Data
Oct. 15, 2014 (JP) 2014-210741

(51) Int. Cl. G02B 27/00; G02B 1/115

(52) U.S. Cl. CPC G02B 27/0018; G02B 1/115

(57) ABSTRACT

An optical element includes: an optical element substrate; a first light shielding film that covers a non-optical path portion of the optical element substrate; a functional film that covers an optical path portion of the optical element substrate and the first light shielding film; and a second light shielding film that covers a non-optical path portion of the functional film, in which a region of the functional film which is not covered with the second light shielding film is transparent and has a uneven structure, and a region of the functional film which is covered with the second light shielding film has light reflecting properties. As a result, the optical element such as a lens is provided in which flare characteristics are excellent, and ghosting does not occur.

### CROSS-REFERENCE TO RELATED APPLICATIONS

This application is a Continuation of PCT International Application No. PCT/JP2015/078224 filed on Oct. 5, 2015, which claims priority under 35 U.S.C. §119(a) to Japanese Patent Application No. 2014-210741 filed on Oct. 15, 2014. The above application is hereby expressly incorporated by reference, in its entirety, into the present application.

### BACKGROUND OF THE INVENTION

1. Field of the Invention

The present invention relates to an optical element such as a lens. Specifically, the present invention relates to an optical element having excellent flare characteristics and capable of suppressing ghosting, and a method of manufacturing the same.

2. Description of the Related Art

In an optical element such as a lens which is formed of a light-transmitting medium such as glass or plastic, in a case where surface reflection is severe, flaring and ghosting frequently occur, and the transmittance decreases.

Therefore, an antireflection film formed of a dielectric film is formed on a surface of the optical element.

An antireflection film is required to obtain an excellent antireflection effect even in a case where the incidence angle range of a light flux incident on an optical element is wide.

In order to obtain a high antireflection effect in a wide incidence angle range, it is required that a difference in refractive index between films constituting an interface between air and a layer or between a layer and a layer is small. Therefore, it is efficient to use a functional film having a lower refractive index than a dielectric film. As such an antireflection film, an antireflection film having an uneven structure is known.

In an antireflection film having an uneven structure, the reflectance can be suppressed to be low with respect to light rays incident at a wide angle range from a low angle to a high angle.

As an optical element which includes such an antireflection film having an uneven structure, for example, JP2011-145627A discloses an optical element including: an optical path portion (optically effective portion) on which a sub-wavelength structure of a wavelength used or shorter which includes aluminum or an aluminum oxide is formed; and a non-optical path portion (optically ineffective portion) on which a light shielding film (opaque film) is formed, in which the light shielding film includes a cured product prepared from an epoxy resin and a curing agent formed of an alicyclic acid anhydride.

In addition, JP2012-73590A discloses an optical element including: an protective layer that covers an optical path portion and a non-optical path portion on a substrate; a light shielding film that is formed on the non-optical path portion of the protective film; and a plate-crystal film that is formed on the optical path portion of the protective film and includes an aluminum oxide as a major component, the aluminum oxide having an uneven structure on a surface thereof.

### SUMMARY OF THE INVENTION

The antireflection film having an uneven structure described in JP2011-145627A and JP2012-73590A is a so-called boehmite film which is formed by performing a warm water treatment on an aluminum oxide film or an aluminum film.

In addition, as described in JP2011-145627A and JP2012-73590A, the light shielding film for preventing permeation of abundant light into the optical element, which causes ghosting or flaring, is provided on the non-optical path portion of the optical element.

A boehmite film has poor scratch resistance due to its uneven shape and is easily damaged when sliding in contact with something with only an extremely weak force. Therefore, in a case where the light shielding film is formed after the formation of a boehmite film, the boehmite film may be damaged during the formation of the light shielding film.

In order to solve the problem, it is necessary that, after forming the light shielding film on an aluminum oxide film or the like, a warm water treatment is performed to form a boehmite film.

Here, as described in JP2012-73590A, in many cases, an antireflection film formed of a boehmite film is formed by performing a warm water treatment on an aluminum oxide film.

On the other hand, according to the investigation by the present inventors, it is preferable to form a boehmite film by performing a warm water treatment on an aluminum film rather than on an aluminum oxide film from the viewpoints of a reduction in haze, flare characteristics, and the like.

However, likewise, according to the investigation by the present inventors, in an optical element in which a boehmite film which is formed by performing a warm water treatment on an aluminum film is used as an antireflection film, even a case where a light shielding film for preventing incidence of unnecessary light on a region is formed as described in JP2011-145627A and JP2012-73590A, light is reflected by the aluminum film, and ghosting occurs.

Therefore, although it is advantageous from the viewpoints of flare characteristics and the like, a boehmite film formed of an aluminum film cannot be used in the optical element having the configuration of the related art.

An object of the present invention is to solve the above-described problems of the related art and is to provide an optical element including an antireflection film with reduced haze which is formed of a metal film or an alloy film and has an uneven structure, in which incidence of light on the metal film or the alloy film is prevented, flare characteristics are excellent, and ghosting is suppressed.

In order to solve the problem, according to the present invention, there is provided an optical element comprising:

an optical element substrate;

a first light shielding film that covers at least a portion of a non-optical path portion on one surface of the optical element substrate;

an interlayer that covers at least a portion of an optical path portion of the optical element substrate and the first light shielding film and has a configuration in which a low refractive index layer having a lower refractive index than the optical element substrate and a high refractive index layer having a higher refractive index than the optical element substrate are laminated;

a functional film that covers the interlayer, or covers the interlayer and at least a portion of the first light shielding film; and

a second light shielding film that covers the functional film in at least a portion of the non-optical path portion of the optical element substrate,

in which a region of the functional film which is not covered with the second light shielding film is transparent and has an uneven structure, and

a region of the functional film which is covered with the second light shielding film has light reflecting properties.

In the optical element according to the present invention, it is preferable that a portion of the second light shielding film contacting the light-reflecting region of the functional film has a size which is equal to or less than that of the first light shielding film.

In addition, it is preferable that the region of the functional film which is covered with the second light shielding film is formed of a metal or an alloy.

In addition, it is preferable that the metal is aluminum and that the alloy is an aluminum alloy.

In addition, according to the present invention, there is provided a method of manufacturing an optical element comprising:

a step of forming a first light shielding film on at least a portion of a non-optical path portion on one surface of the optical element substrate;

a step of forming an interlayer that covers at least a portion of an optical path portion of the optical element substrate and the first light shielding film and has a configuration in which a low refractive index layer having a lower refractive index than the optical element substrate and a high refractive index layer having a higher refractive index than the optical element substrate are laminated;

a step of forming a reflection film to cover the interlayer, or cover the interlayer and at least a portion of the first light shielding film;

a step of forming a second light shielding film to cover the reflection film in at least a portion of the non-optical path portion of the optical element substrate; and

a step of performing a warm water treatment on the reflection film.

In the method of manufacturing an optical element according to the present invention, it is preferable that a portion of the second light shielding film contacting the reflection film has a size which is equal to or less than that of the first light shielding film.

In addition, it is preferable that the reflection film is a metal film or an alloy film.

In addition, it is preferable that the reflection film is an aluminum film or an aluminum alloy film.

According, to the present invention, by providing the antireflection film with reduced haze which is formed of a metal film or an alloy film and has an uneven structure, flare characteristics can be made to be excellent. In addition, by providing the first light shielding film and the second light shielding film, permeation of unnecessary light into the optical element can be prevented, and unnecessary reflection of light from the metal film or the like can be prevented.

Therefore, according to the present invention, a high performance optical element can be obtained in which flare characteristics are excellent, and ghosting is suppressed.

### BRIEF DESCRIPTION OF THE DRAWINGS

FIG. 1 is a diagram schematically showing an example of an optical element according to the present invention.

FIG. 2A is a partially enlarged view of FIG. 1.

FIG. 2B is a schematic diagram showing another example of the optical element according to the present invention.

FIG. 2C is a schematic diagram showing still another example of the optical element according to the present invention.

FIG. 3 is a graph showing the results of measuring a reflectance in Examples.

FIG. 4 is a graph showing the results of measuring a spatial frequency in Examples.

FIG. 5 is a schematic diagram showing a method of measuring a scattered light intensity in Examples.

### DESCRIPTION OF THE PREFERRED EMBODIMENTS

Hereinafter, an optical element and a method of manufacturing an optical element according to the present invention will be described in detail based on a preferable embodiment shown in the accompanying drawings.

In this specification, numerical ranges represented by “to” include numerical values before and after “to” as lower limit values and upper limit values.

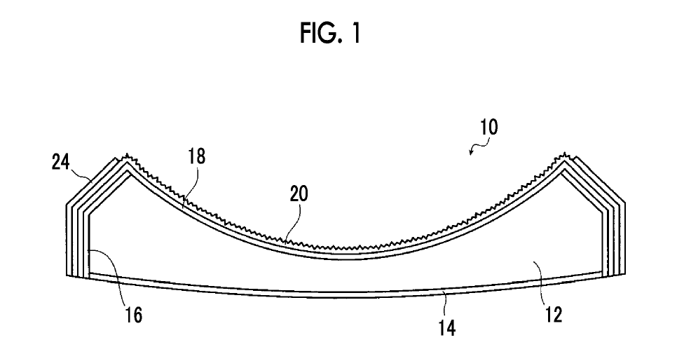

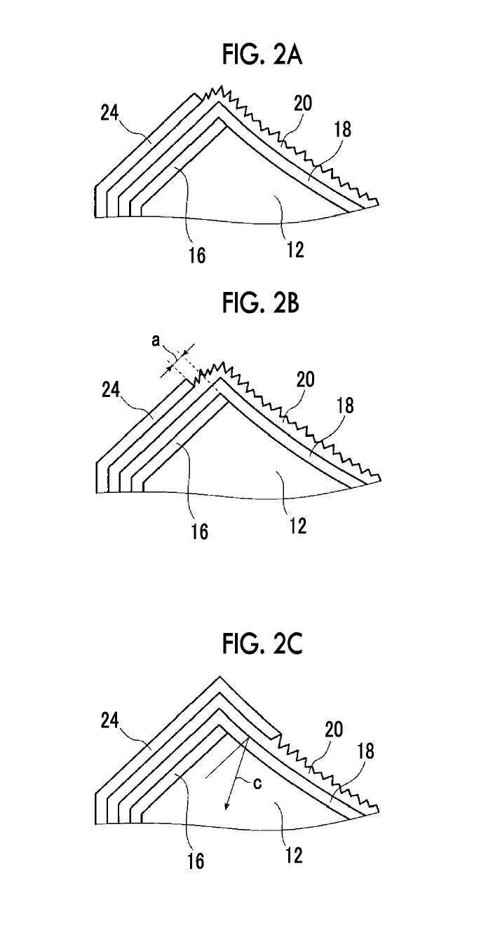

FIG. 1 is a diagram schematically showing an example of the optical element according to the present invention. In addition, FIG. 2A is a partially enlarged view of FIG. 1.

An optical element 10 shown in FIG. 1 includes an optical element substrate 12, an antireflection coating 14, a first light shielding film 16, an interlayer 18, a functional film 20, and a second light shielding film 24. In the optical element 10 shown in the drawing, light is incident from above, a region having a recessed shape on the light incidence side is an optical path portion, and a region positioned outside of the optical path portion is a non-optical path portion. In other words, the optical path portion is an effective region. In addition, in other words, the non-optical path portion is an ineffective region.

In the present invention, in the design of the optical element, the optical path portion is a region (effective region) where passage of light is assumed and where light passing through the optical path portion can be effectively modulated. In addition, the non-optical path portion is a region (ineffective region) of the optical element excluding the optical path portion.

### Optical Element Substrate

The optical element substrate 12 is a well-known optical element. Specific examples of the optical element substrate 12 include a lens such as a convex lens, a concave lens, or a meniscus lens, and flat glass.

In the example shown in the drawing, the optical element substrate 12 (optical element 10) is a concave lens. In addition, the planar shape of the optical element substrate 12 is, for example, spherical. In other words, the planar shape of the optical element substrate 12 is a shape of the optical element substrate 12 when seen from an optical axis direction.

As a material for forming the optical element substrate 12, various well-known transparent materials, such as glass or a resin material, which are used in an optical element can be used. In addition, as the material for forming the optical element substrate 12, commercially available materials for forming an optical element may be used.

Here, “transparent” represents a transmittance being 10% or higher with respect to light in a wavelength range of 400 to 700 nm. Regarding this point, the same shall be applied to the functional film and the like described below.

### Antireflection Coating

In the optical element 10, the antireflection coating 14 is provided on a light exit surface of the optical element substrate 12 opposite to the surface having a recessed surface. In a preferable embodiment, the antireflection coating 14 is provided and is a well-known antireflection coating, such as a lens, which is used in an optical element.

Examples of the antireflection coating 14 include a dielectric multi-layer film in which a dielectric layer having a high refractive index and a dielectric layer having a low refractive index are laminated. Examples of a material for forming the dielectric layer having a high refractive index include Sb₂O₃, Sb₂S₃, Bi2O₃, CeO₂, CeF₃, HfO₂, La₂O₃, Nd₂O₃, Pr₆O₁₁, Sc₂O₃, SiO, Ta₂O₅, TiO₂, TlCl, Y₂O₃, ZnSe, ZnS, and ZrO₂.

In addition, examples of a material for forming the dielectric layer having a low refractive index include Al₂O₃, BiF₃, CaF₂, LaF₃, PbCl₂, PbF₂, LiF, MgF₂, MgO, NdF₃, SiO₂, Si₂O₃, NaF, ThO₂, and ThF₄.

The thickness of the antireflection coating 14 and the thickness of each of the dielectric layers for forming the antireflection coating may be appropriately set to exhibit a desired function depending on the materials for forming the respective layers and the like.

### First Light Shielding Film

Incidentally, the first light shielding film 16 is formed on the non-optical path portion of the optical element substrate 12 on the light incident surface side. In a preferable embodiment, in the optical element 10 shown in the example of the drawing, the first light shielding film 16 is formed not only on the light incident surface of the optical element substrate 12 but also on end surfaces of the optical element substrate 12. Regarding this point, the same shall be applied to the interlayer 18, the functional film 20, and the second light shielding film 24 described below. In other words, the end surfaces of the optical element substrate 12 are surfaces perpendicular to the optical axis.

The first light shielding film 16 prevents incidence of light on a light-reflecting region of the functional film 20 described below.

In the optical element 10 according to the present invention, in a case where the functional film 20 having an uneven structure, which is formed by performing a warm water treatment on a metal or an alloy, is provided as an antireflection film on the optical path portion, the above-described first light shielding film 16 is provided in addition to the second light shielding film 24 for preventing incidence of unnecessary light which is generally formed in an optical element. In the optical element 10 according to the present invention, by providing the first light shielding film 16, reflection of light from the light-reflecting region of the functional film described below is prevented, flare characteristics are excellent, and ghosting is suppressed, thereby realizing the high performance optical element 10.

As a material for forming the first light shielding film 16, various well-known materials which are used for shielding light in an optical element can be used.

Examples of the material for forming the first light shielding film 16 include: materials obtained by dispersing tar, pitch, a dye, a pigment, mica particles, silica particles, or the like in a binder such as an epoxy resin or a phenol resin; and various coating materials which are used for shielding light.

In addition, as the material for forming the first light shielding film 16, a commercially available product such as GT-7, GT7-A, or GT-1000 (manufactured by Canon Chemicals Inc.) may be used.

The thickness of the first light shielding film 16 may be appropriately set to obtain desired light shielding properties depending on the material for forming the first light shielding film 16.

Specifically, the thickness of the first light shielding film 16 is preferably 2 to 10 μm and more preferably 4 to 6 μm.

It is not necessary that the first light shielding film 16 covers the entire surface of the non-optical path portion of the optical element substrate 12. For example, in the optical element substrate 12, the first light shielding film 16 is not necessarily formed in a region where the functional film 20 described below is not foil led and a region where the second light shielding film 24 is not formed.

### Interlayer

In the optical element 10 shown in the example of the drawing, the interlayer 18 is formed to cover the first light shielding film 16 and the optical path portion of the optical element substrate 12. It is not necessary that the interlayer 18 covers the entire area of the first light shielding film 16.

In a preferable embodiment, the interlayer 18 is provided and is a layer for causing interference to suppress reflected light derived from a difference in refractive index between the optical element substrate 12 and the functional film 20 described below. In the present invention, it is preferable that the interlayer 18 has a layer in which a low refractive index layer having a lower refractive index than the optical element substrate 12 and a high refractive index layer having a higher refractive index than the optical element substrate 12 are alternately laminated.

Examples of a specific configuration of the interlayer 18 include: a configuration in which the low refractive index layer and the high refractive index layer are laminated in this order from the optical element substrate 12 side; a configuration in which the high refractive index layer and the low refractive index layer are laminated in this order from the optical element substrate 12 side; a configuration in which the low refractive index layer, the high refractive index layer, the low refractive index layer, and the high refractive index layer are laminated in this order from the optical element substrate 12 side; a configuration in which the high refractive index layer, the low refractive index layer, the high refractive index layer, and the low refractive index layer are laminated in this order from the optical element substrate 12 side; a configuration in which the low refractive index layer, the high refractive index layer, the low refractive index layer, the high refractive index layer, the low refractive index layer, and the high refractive index layer are laminated in this order from the optical element substrate 12 side; and a configuration in which the high refractive index layer, the low refractive index layer, the high refractive index layer, the low refractive index layer, the high refractive index layer, and the low refractive index layer, are laminated in this order from the optical element substrate 12 side.

The refractive indices of the low refractive index layer and the high refractive index layer are relatively determined with respect to layers adjacent thereto and thus are not particularly limited. The refractive index of the low refractive index layer is preferably 1.45 to 1.8, and the refractive index of the high refractive index layer is preferably 1.6 to 2.4.

In addition, each of the thicknesses of the low refractive index layer and the high refractive index layer may be appropriately set based on, for example, a relationship between the refractive index thereof and the wavelength of reflected light. Specifically, the thickness of the low refractive index layer is preferably 8 to 160 nm, and the thickness of the high refractive index layer is preferably 4 to 16 nm.

Examples of a material of the low refractive index layer include silicon oxide, silicon oxynitride, gallium oxide, aluminum oxide, lanthanum oxide, lanthanum fluoride, and magnesium fluoride.

Examples of a material of the high refractive index layer include silicon oxynitride, niobium oxide, silicon-niobium oxide, zirconium oxide, tantalum oxide, silicon nitride, and titanium oxide.

### Functional Film

The functional film 20 has an uneven structure on the surface of the optical path portion and functions as an antireflection film.

Here, a region of the functional film 20 which is not covered with the second light shielding film 24 is formed of a metal hydrate or an alloy hydrate, is transparent, and has an uneven structure, the metal hydrate or the alloy hydrate being formed by performing a warm water treatment on a metal or an alloy. In addition, a region of the functional film 20 which is covered with the second light shielding film 24 is formed of a metal or an alloy and has light reflecting properties.

As described in JP2011-145627A and JP2012-73590A, typically, a boehmite film which is used as an antireflection film in an optical element is formed by performing a warm water treatment on aluminum oxide.

On the other hand, in the optical element 10 according to the present invention, the functional film 20 which includes the region having an uneven structure and the light-reflecting region is formed by performing a warm water treatment on a metal such as aluminum or an alloy such as an aluminum alloy. As a result, as compared to a boehmite film which is formed by performing a warm water treatment on aluminum oxide, haze in the region having an uneven structure which forms the optical path portion can be suppressed, and the optical element 10 having excellent flare characteristics can be realized.

The uneven structure of the functional film 20 is not particularly limited as long as it has a shorter average distance between convex portions (average pitch) than a wavelength of antireflection target light.

Typically, the average distance between convex portions (average pitch) of the uneven structure is several tens to several hundreds of nanometers, preferably 150 nm or shorter, and more preferably 100 nm or shorter.

“Distances between convex portions” (pitches) are distances between peaks of most adjacent convex portions which separate concave portions from each other. “The average distance between convex portions (average pitch)” can be obtained by obtaining a surface image of the functional film 20 using a scanning electron microscope (SEM), processing the surface image to binarize image data, and performing a statistical procedure.

Although not particularly limited, a peak value of spatial frequency of the uneven structure in the functional film 20 is preferably as high as possible from the viewpoint that light scattering can be suitably suppressed.

Specifically, the peak value of spatial frequency of the uneven structure in the functional film 20 is preferably 6.5 μm⁻¹ or higher, more preferably 9 μm⁻¹ or higher, and still more preferably 10 to 30 μm⁻¹.

Here, “the peak value of spatial frequency of the functional film 20” is a peak value of an intensity spectrum corresponding to a spatial frequency magnitude which is obtained by performing two-dimensional Fourier transformation on the SEM image of the surface of the functional film 20 and integrating the obtained two-dimensional spatial frequency intensity spectra in an azimuthal direction.

In addition, the thickness of the region of the functional film 20 having an uneven structure, that is, the region of the functional film 20 which is not covered with the second light shielding film 24 is preferably 50 to 400 nm and more preferably 100 to 250 nm.

Here, “the thickness of the region of the functional film 20 having an uneven structure” refers to the length of a perpendicular line from the peak of a convex portion to an interface between the functional film 20 and the interlayer. In a case where the interlayer is not provided, “the thickness of the region of the functional film 20 having an uneven structure” refers to the length of a perpendicular line from the peak of a convex portion to an interface between the functional film 20 and the optical element substrate.

The non-optical path portion of the functional film 20, that is, the light-reflecting region has the same thickness as a metal layer or an alloy layer on which the uneven structure is not formed. The thickness of the region having an uneven structure which is formed after a warm water treatment is larger than that of the metal layer or the alloy layer before the warm water treatment. Accordingly, the thickness of the light-reflecting region in the functional film 20 is smaller than that of the region having an uneven structure.

As a material for forming the uneven structure of the functional film 20, various metal hydrates or alloy hydrates which are formed by performing a warm water treatment on various metals or alloys can be used.

Specific examples of the material for forming the uneven structure of the functional film 20 include a metal hydrate or an alloy hydrate which is obtained by performing a warm water treatment on a metal such as aluminum or titanium and an alloy such as aluminum/titanium alloy or aluminum/silicon alloy.

Accordingly, examples of a material for forming the light-reflecting region of the functional film 20 include the above-described metal or alloy.

### Second Light Shielding Film

The second light shielding film 24 is formed on the non-optical path portion of the functional film 20.

The second light shielding film 24 is a light shielding film for preventing permeation of unnecessary light into the optical element 10.

The second light shielding film 24 may be formed of the same material as the first light shielding film 16 described above.

The thickness of the second light shielding film 24 may be appropriately set to obtain desired light shielding properties depending on the material for forming the second light shielding film 24. Specifically, the thickness of the second light shielding film 24 is preferably 2 to 10 μm and more preferably 4 to 6 μm.

Here, regarding the first light shielding film 16 and the second light shielding film 24, it is preferable that a region of the second light shielding film 24 contacting the functional film 20 has a size which is equal to or less than that of a region corresponding to the first light shielding film 16 as schematically shown in FIGS. 2A and 2B

In other words, it is preferable that the first light shielding film 16 and the second light shielding film 24 are formed such that the region of the second light shielding film 24 contacting the functional film 20 is included in the first light shielding film 16 in a plane direction of the functional film 20.

As described above, in the optical element 10 according to the present invention, the region (non-optical path portion) of the functional film 20 which is covered with the second light shielding film 24 is formed of a metal or an alloy and has light reflecting properties. Here, as schematically shown in FIG. 2C, in a case where the first light shielding film 16 is smaller than the second light shielding film 24, that is, the second light shielding film 24 protrudes from the first light shielding film 16 in the plane direction of the functional film 20, light is incident on the light-reflecting region of the functional film 20 and is reflected as indicated by arrow c in the drawing, which causes ghosting.

On the other hand, by setting the size of the first light shielding film 16 to be equal (FIG. 2A) or larger (FIG. 2B) than the second light shielding film 24, incidence of light on the non-optical path portion of the functional film 20, that is, the light-reflecting region is prevented, and ghosting caused by the incidence can be prevented.

Here, a difference in size between the first light shielding film 16 and the second light shielding film 24, specifically, an amount a of the first light shielding film 16 shown in FIG. 2B protruding from the second light shielding film 24 in the plane direction may be 0 μm or more.

It is not necessary that the second light shielding film 24 covers the entire surface of the non-optical path portion of the optical element substrate 12. For example, in a case where the optical element 10 is mounted on a corresponding optical device, the second light shielding film 24 is not necessarily formed in a portion of the optical device where light is shielded by an attachment member or the like.

### Method of Manufacturing Optical Element

Hereinafter, the optical element 10 according to the present invention will be described in more detail by describing a method of manufacturing the optical element 10.

First, the optical element substrate 12 is prepared. The optical element substrate 12 may be prepared by polishing or molding an optical material such as a lens glass material, or a single optical element such as a commercially available lens may be used.

Next, the antireflection coating 14 formed of a dielectric multi-layer film is formed on the light exit surface of the optical element substrate 12. The antireflection coating 14 may be formed using a well-known method such as sputtering or vacuum deposition depending on the material for forming the antireflection coating 14.

Next, the first light shielding film 16 is formed on the non-optical path portion of the optical element substrate 12. In the example of the drawing, in a preferable embodiment, the first light shielding film 16 is formed even on the end surfaces of the optical element substrate 12.

The first light shielding film 16 may be formed using a well-known method such as a coating method or a printing method (for example, an ink jet method) depending on the material for forming the first light shielding film 16.

Next, the interlayer 18 is formed to cover the optical path portion of the optical element substrate 12 and the first light shielding film 16. Accordingly, the interlayer 18 is formed even on the end surfaces of the optical element substrate 12.

As described above, the interlayer 18 is formed of the low refractive index layer and the high refractive index layer. The interlayer 18 may be formed using a well-known vapor deposition method such as vacuum deposition, plasma sputtering, electron cyclotron sputtering, or ion plating depending on the materials for forming the low refractive index layer and the high refractive index layer.

Next, a metal film or an alloy film which forms the functional film 20 is formed to cover the interlayer 18. Therefore, the metal film or the alloy film which forms the functional film 20 is also formed even on the end surfaces of the optical element substrate 12.

The metal film or the alloy film may be formed using a well-known vapor deposition method such as sputtering, vacuum deposition, plasma CVD, or ion plating depending on the material for forming the metal film or the alloy film.

Next, the second light shielding film 24 is formed on the non-optical path portion of the metal film or the alloy film. In the example of the drawing, in a preferable embodiment, the second light shielding film 24 is formed even on the end surfaces of the optical element substrate 12.

The second light shielding film 24 may be formed of the same material as the first light shielding film 16. In addition, as described above, it is preferable that the region of the second light shielding film 24 contacting the functional film 20, that is, contacting the metal film or the alloy film is smaller than the region corresponding to the first light shielding film 16.

After the second light shielding film 24 is formed, a warm water treatment is performed on the metal film or the alloy film. As a result, the functional film 20 is formed where a region which is covered with the second light shielding film 24 has light reflecting properties and where a region which is not covered with the second light shielding film 24 is transparent and has an uneven structure.

Here, a method of performing a warm water treatment is not particularly limited, and various well-known methods can be used. Examples of the method of performing a warm water treatment are as follows:

(1) a method (method A) of dipping the film in warm water (including boiling water) at 60° C. to a boiling temperature for 1 minute or longer;

(2) a method (method B) of dipping the film in an alkali aqueous solution at 60° C. to a boiling temperature for 1 minute or longer;

(3) a method of exposing the film to water vapor.

By performing the above-described warm water treatment, the metal film or the alloy film undergoes peptization or the like such that it is converted into a metal hydrate or an alloy hydrate, the uneven structure is formed on the optical path portion which is not covered with the second light shielding film 24, and the optical path portion is transparent.

In addition, the non-optical path portion of the metal film or the alloy film which is covered with the second light shielding film 24 does not undergo the warm water treatment and thus is formed of the metal or the alloy having light reflecting properties without any change.

In the present invention, it is preferable that the warm water treatment is performed using the method A or the method B, and it is more preferable that pure water having an electrical resistivity of 10 MΩ·cm or higher is used as the warm water or water which is a material of the alkali aqueous solution.

The electrical resistivity is a value measured at a water temperature of 25° C.

In the present invention, as described above, the functional film 20 which is obtained by performing the warm water treatment on the metal film or the alloy film and has the transparent uneven-structure region is provided, and the first light shielding film 16 is provided. As a result, the optical element can be realized in which flare characteristics are excellent, and ghosting is suppressed.

As shown in JP2012-73590A and the like, typically, a so-called boehmite film which is obtained by performing a warm water treatment on aluminum oxide is used as an antireflection film having an uneven structure.

However, according to the investigation by the present inventors, in a case where an antireflection film having an uneven structure which is formed of a metal hydrate or an alloy hydrate is obtained by performing the warm water treatment on a metal film such as aluminum or an alloy film such as an aluminum alloy instead of aluminum oxide, the antireflection film having reduced haze and excellent flare characteristics can be formed.

On the other hand, the region where the second light shielding film 24 is formed does not undergo the warm water treatment. Therefore, the non-optical path portion of the functional film 20 is formed of a metal film or an alloy film having light reflecting properties, and in a case where light is incident on the non-optical path portion, the incident light is reflected, which causes ghosting. On the other hand, in the optical element 10 according to the present invention, the first light shielding film 16 is provided on the non-optical path portion of the optical element substrate 12. Therefore, incidence of light on the non-optical path portion of the functional film 20, that is, on the light-reflecting region can be prevented, and thus ghosting can be suppressed.

Here, after a metal film or an alloy film is formed, the warm water treatment is performed on the metal film or the alloy film before the formation of the second light shielding film 24. As a result, the entire surface of the metal film or the alloy film can be made to be transparent and to have an uneven structure.

However, the uneven structure formed of a metal hydrate or an alloy hydrate which is obtained by performing the warm water treatment on the metal film or the alloy film has low scratch resistance due to its structure. Therefore, even when sliding in contact with something with a weak force, the uneven structure is easily damaged, which causes deterioration in optical characteristics. Therefore, in a case where the second light shielding film 24 is formed after the uneven structure is formed by performing the warm water treatment on the metal film or the alloy film, the uneven structure is damaged during the formation of the second light shielding film 24, and this damages and the like may cause a significant deterioration in the optical characteristics of the optical element.

On the other hand, in the present invention, the warm water treatment is performed after the formation of the second light shielding film 24. As a result, the uneven structure of the functional film 20 can be prevented from being damaged by the formation of the second light shielding film 24.

That is, in the present invention, the functional film 20 is formed by performing the warm water treatment on the metal film or the alloy film, and the second light shielding film 24 is formed before the warm water treatment. As a result, the light-reflecting region is caused to remain in the functional film 20. In addition, by providing the first light shielding film 16, incidence of light on the light-reflecting region of the functional film 20 is prevented, flare characteristics are excellent, ghosting is suppressed, damages of the functional film 20 are suppressed, thereby realizing the high performance optical element 10.

Hereinafter, the optical element and the method of manufacturing an optical element according to the present invention have been described. However, the present invention is not limited to the above-described examples, and various improvements and modifications can be made within a range not departing from the scope of the present invention.

### EXAMPLES

Hereinafter, the present invention will be described in more detail using specific examples according to the present invention.

### Example 1

By polishing a lens glass material (S-NPH3, manufactured by Ohara Inc.) the optical element substrate 12 (single concave lens) having a shape shown in FIG. 1 was formed.

A dielectric multi-layer film as the antireflection coating 14 was formed on the light exit surface of the optical element substrate 12 using a vacuum deposition method, the dielectric multi-layer film having a thickness of 327 nm and a configuration of MgF₂/ZrO₂/SiO₂/ZrO₂/SiO₂/ZrO₂/SiO₂/Glass.

Next, the first light shielding film 16 having a thickness of 5 μm was formed on the non-optical path portion and the end surfaces of the optical element substrate 12 using a coating material for an optical element (GT-1000, manufactured by Canon Chemicals Inc.).

Next, the interlayer 18 formed of silicon oxynitride was formed by sputtering to cover the first light shielding film 16 and the optical path portion of the optical element substrate 12. The interlayer 18 had a two-layer configuration including: a first layer having a thickness of 63 nm and a refractive index of 1.845 (540 nm) that is formed on the substrate side; and a second layer having a thickness of 110 nm and a refractive index of 1.684 (540 nm) that is formed on the first layer.

Next, an aluminum film (Al film) having a thickness of 40 nm was formed by sputtering to cover the interlayer 18.

Next, the second light shielding film 24 having a thickness of 5 μm was formed on the non-optical path portion and the end surfaces of the aluminum film using a coating material for an optical element (GT-1000, manufactured by Canon Chemicals Inc.).

Further, the optical element substrate 12 on which the second light shielding film 24 was formed was dipped in boiling ultrapure water (having an electrical resistivity of 12 MΩ·cm or higher) for 3 minutes such that a warm water treatment was performed on the aluminum film. Due to the warm water treatment, the functional film 20 was formed including: the light-reflecting region which was covered with the second light shielding film 24; and the transparent uneven-structure region which was not covered with the second light shielding film 24. As a result, the optical element 10 (concave lens) was prepared. The thickness of the region of the functional film 20 having an uneven structure was 300 nm.

Incidentally, a flat glass (S-NPH3, manufactured by Ohara Inc.) formed of a lens glass material was prepared.

A first light shielding film having a thickness of 5 μm was formed on a half region of a single surface of the flat glass using a coating material for an optical element (GT-1000, manufactured by Canon Chemicals Inc.).

Next, an interlayer formed of silicon oxynitride was formed by sputtering to cover the entire surface of the surface of the flat glass where the first light shielding film was formed. The interlayer 18 had a two-layer configuration including: a first layer having a thickness of 63 nm and a refractive index of 1.845 (540 nm) that is formed on the flat glass side; and a second layer having a thickness of 110 nm and a refractive index of 1.684 (540 nm) that is formed on the first layer.

Next, an aluminum film having a thickness of 40 nm was formed by sputtering to cover the interlayer.

Next, a second light shielding film having a thickness of 5 μm was formed on the interlayer to cover a half region of the interlayer corresponding to the half region of the first light shielding film, which was formed in advance, using a coating material for an optical element (GT-1000, manufactured by Canon Chemicals Inc.).

Further, the flat glass on which the second light shielding film was formed was dipped in boiling ultrapure water (having an electrical resistivity of 12 MΩ·cm) for 3 minutes such that a warm water treatment was performed on the aluminum film. Due to the warm water treatment, a functional film was formed including: a light-reflecting region which was covered with the second light shielding film; and a transparent uneven-structure region which was not covered with the second light shielding film. The thickness of the region of the functional film having an uneven structure was 300 nm.

### Comparative Example 1

An optical element (concave lens) on which the interlayer 18, the functional film 20 having the light-reflecting region and the transparent uneven-structure region, and the second light shielding film 24 were provided was formed using the same method as in Example 1, except that the first light shielding film 16 was not formed. The thickness of the region of the functional film 20 having an uneven structure was 300 nm.

In addition, a flat glass in which the interlayer, the functional film having the light-reflecting, region and the transparent uneven-structure region, and the second light shielding film covering half of the surface were provided on a single surface was prepared using the same method as in Example 1, except that the first light shielding film was not formed. The thickness of the region of the functional film having an uneven structure was 300 nm.

### Comparative Example 2

An optical element (concave lens) on which the interlayer 18, the functional film having the transparent uneven-structure region, and the second light shielding film 24 were provided was formed using the same method as in Example 1, except that: the first light shielding film 16 was not formed; and the functional film was formed by performing the wan water treatment on an aluminum oxide film (Al₂O₃ film) having a thickness of 80 nm instead of the aluminum film. The thickness of the region of the functional film 20 having an uneven structure was 300 nm.

A flat glass in which the interlayer, the functional film having the transparent uneven-structure region, and the second light shielding film covering half of the surface were provided on a single surface was prepared using the same method as in Example 1, except that: the first light shielding film was not formed; and the functional film was formed by performing the warm water treatment on an aluminum oxide film having a thickness of 80 nm instead of the aluminum film. The thickness of the region of the functional film having an uneven structure was 300 nm.

In this example, the functional film was foamed by performing the warm water treatment on the aluminum oxide film. Therefore, the functional film did not include the light-reflecting region.

### Measurement of Microscopic Reflectance

On a surface of each of the prepared flat glass plates opposite to the surface where the second light shielding film was formed, the microscopic reflectance of a region where the second light shielding film was formed was measured.

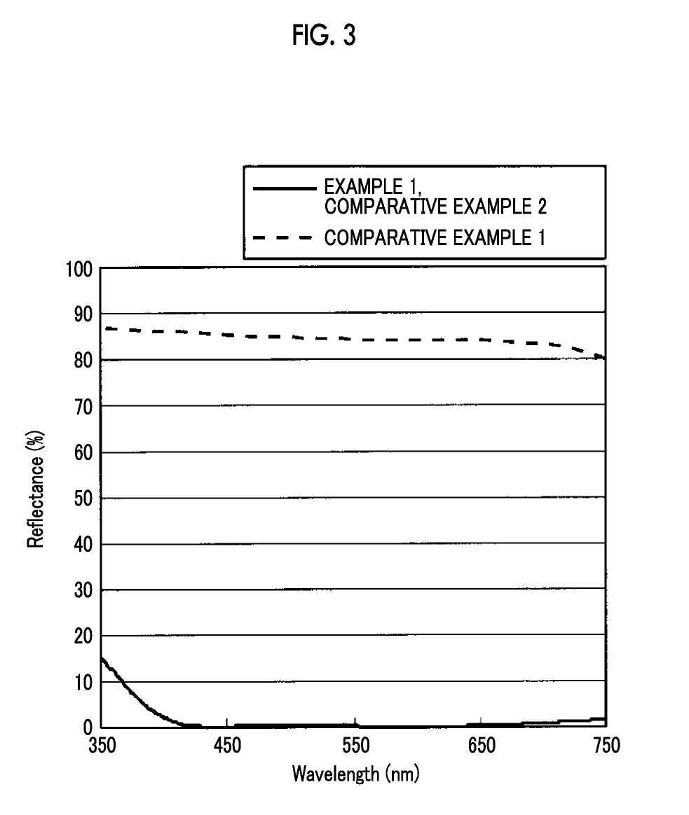

The results are shown in FIG. 3.

It can be seen from FIG. 3 that, in Example 1 in which the first light shielding film was provided and in Comparative Example 2 in which the functional film was formed using the aluminum oxide film, the reflectance of light in a visual region was 5% or lower, and ghosting caused by incidence of light on the non-optical path portion of the functional film was suppressed.

On the other hand, in Comparative Example 1 in which the functional film was formed using the aluminum film and the first light shielding film was not provided, the reflectance of light in a visual region was 80% to 90%, and ghosting caused by incidence of light on the non-optical path portion of the functional film was not able to be suppressed.

### Measurement of Peak Value of Spatial Frequency

The peak value of spatial frequency of the uneven structure of each of the prepared flat glass plates was measured. The peak value of spatial frequency was calculated from spatial frequency spectra which was obtained by performing two-dimensional Fourier transformation on an electron microscope image obtained using a scanning electron microscope (S-4100, manufactured by Hitachi Ltd.).

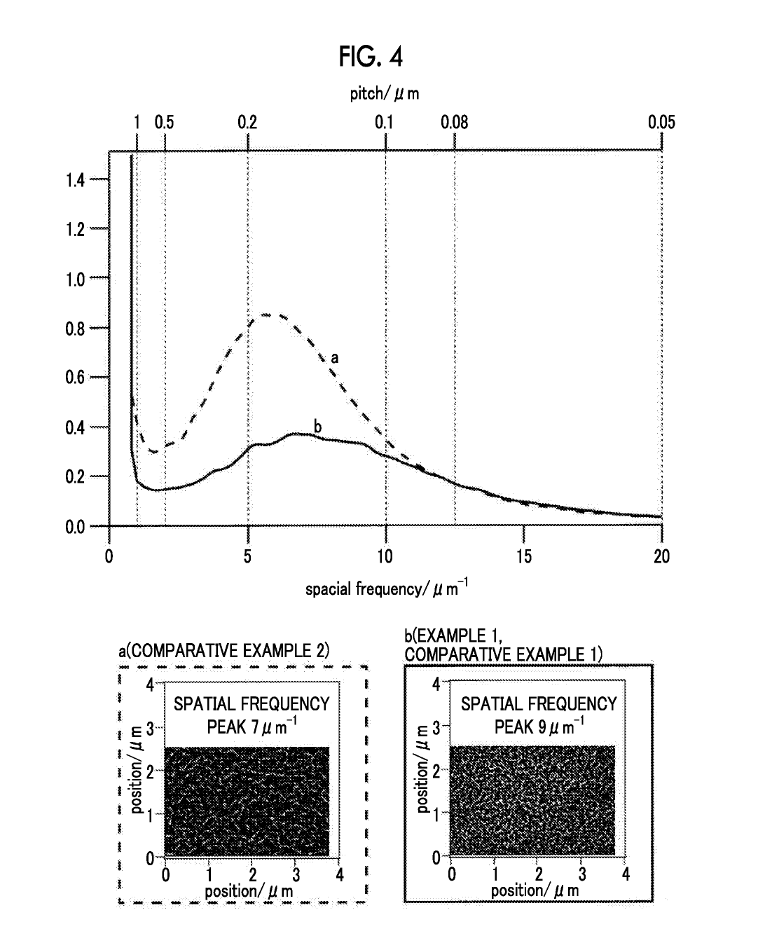

The results are shown in FIG. 4.

As can be seen from FIG. 4, the peak values of spatial frequency of Example 1 and Comparative Example 1 were 9 μm⁻¹, and the peak value of spatial frequency of Comparative Example 2 was 7 μm⁻¹. Therefore, in Example 1 and Comparative Example 1 in which the functional film was formed by performing the warm water treatment on the aluminum film, light scattering was able to be suppressed as compared to Comparative Example 2 in which the functional film was formed by performing the warm water treatment on the aluminum oxide film.

### Measurement of Scattered Light Amount

The scattered light amount of the uneven structure of each of the prepared flat glass plates was measured.

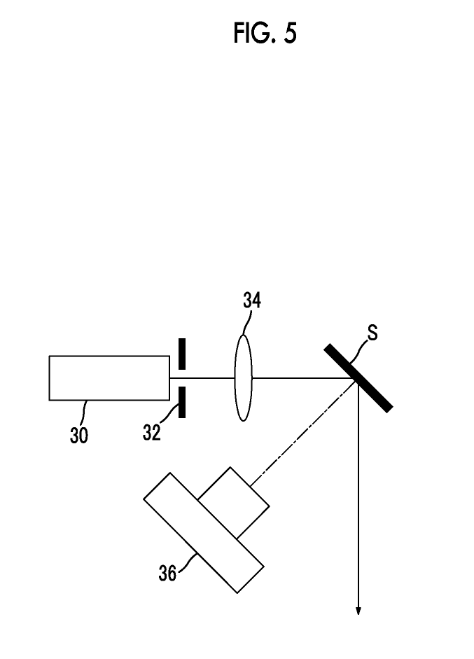

The scattered light amount was measured as follows. That is, as schematically shown in FIG. 5, light emitted from an Xe lamp light source 30 was narrowed by an iris 32 having an aperture of 3 mm and was collected on a region having the uneven structure of each of flat glass plates S as a sample at an incidence angle of 45° using a collecting lens 34 of f=100 mm.

In this state, using a digital still camera 36 (Fine pix S3 pro, manufactured by Fujifilm Corporation) on which a lens (manufactured by Nikon Corporation) having a focal length f of 85 mm and an F-number of 4.0 was mounted, the surface of the flat glass plate S was imaged under conditions of ISO speed: 200 and shutter speed: ½ sec. The average of pixel values in a light collecting region of 128×128 pixels was obtained as a scattered light amount.

As a result, the scattered light amounts of Example 1 and Comparative Example 1 were 8.5, and the scattered light amount of Comparative Example 2 was 13.4. Therefore, in Example 1 and Comparative Example 1 in which the functional film was formed by performing the warm water treatment on the aluminum film, light scattering was able to be suppressed as compared to Comparative Example 2 in which the functional film was formed by performing the warm water treatment on the aluminum oxide film.

### Lens Characteristics

Each of the prepared optical elements (concave lenses) was incorporated into an optical system of a camera lens, a ghost image was actually obtained and observed.

As a result, in the optical element according to Example 1, ghosting derived from the optical element was not observed. In addition, flare characteristics and the external appearance of the optical element were excellent.

On the other hand, in the optical element according to Comparative Example 1 in which the first light shielding film 16 was not provided, flare characteristics and the external appearance of the optical element were excellent. However, ghosting derived from the optical element was observed.

In addition, in the optical element according to Comparative Example 2 in which the functional film was formed using the aluminum oxide film, ghosting derived from the optical element was not observed. However, as compared to the other examples, flare characteristics were poor, and the optical element was slightly white.

The above results are collectively shown in the following table.

TABLE 1

| | Source of | First Light | | Peak | Scattered | Lens | |
|---|---|---|---|---|---|---|---|
| | Functional | Shielding | Reflectance | Value | Light | Characteristics | |
| | Film | Film | [%] | [μm⁻¹] | Amount | Ghosting | Flaring |
| Example 1 | Al | Provided | 5 or lower | 9 | 8.5 | Excellent | Excellent |
| Comparative | Al | Not | 80 to 90 | 9 | 8.5 | Poor | Excellent |
| Example 1 | | Provided | | | | | |
| Comparative | Al₂O₃ | Not | 5 or lower | 7 | 13.4 | Excellent | Poor |
| Example 2 | | Provided | | | | | |

“Peak Value” refers to a peak value of spatial frequency

As can be seen from the above results, the effects of the present invention are obvious.

### INDUSTRIAL APPLICABILITY

The present invention is suitably applicable to various optical elements such as a camera lens.

### EXPLANATION OF REFERENCES

10: optical element

12: optical element substrate

14: antireflection coating

16: first light shielding film

18: interlayer

20: functional film

24: second light shielding film

What is claimed is:

1. An optical element comprising:
an optical element substrate;
a first light shielding film that covers at least a portion of a non-optical path portion on one surface of the optical element substrate;
an interlayer that covers at least a portion of an optical path portion of the optical element substrate and the first light shielding film and has a configuration in which a low refractive index layer having a lower refractive index than the optical element substrate and a high refractive index layer having a higher refractive index than the optical element substrate are laminated;
a functional film that covers the interlayer, or covers the interlayer and at least a portion of the first light shielding film; and
a second light shielding film that covers the functional film in at least a portion of the non-optical path portion of the optical element substrate,
wherein a region of the functional film which is not covered with the second light shielding film is transparent and has an uneven structure, and
a region of the functional film which is covered with the second light shielding film has light reflecting properties.

2. The optical element according to claim 1,
wherein a portion of the second light shielding film contacting the light-reflecting region of the functional film has a size which is equal to or less than that of the first light shielding film.

3. The optical element according to claim 1,
wherein the region of the functional film which is covered with the second light shielding film is formed of a metal or an alloy.

4. The optical element according to claim 3,
wherein the metal is aluminum, and
the alloy is an aluminum alloy.

5. A method of manufacturing an optical element comprising:
a step of forming a first light shielding film on at least a portion of a non-optical path portion on one surface of the optical element substrate;
a step of forming an interlayer that covers at least a portion of an optical path portion of the optical element substrate and the first light shielding film and has a configuration in which a low refractive index layer having a lower refractive index than the optical element substrate and a high refractive index layer having a higher refractive index than the optical element substrate are laminated;
a step of forming a reflection film to cover the interlayer, or cover the interlayer and at least a portion of the first light shielding film;
a step of forming a second light shielding film to cover the reflection film in at least a portion of the non-optical path portion of the optical element substrate; and
a step of performing a warm water treatment on the reflection film.

6. The method of manufacturing an optical element according to claim 5,
wherein a portion of the second light shielding film contacting the reflection film has a size which is equal to or less than that of the first light shielding film.

7. The method of manufacturing an optical element according to claim 5,
wherein the reflection film is a metal film or an alloy film.

8. The method of manufacturing an optical element according to claim 7,
wherein the reflection film is an aluminum film or an aluminum alloy film.
